(19) United States
(12) Patent Application Publication
(10) Pub. No.: US 2013/0055893 A1
(43) Pub. Date: Mar. 7, 2013

(54) Chamber Air Scrubber Assembly

(71) Applicants: Michael Lowe, Eau Claire, WI (US); Donald Nelson, Eau Claire, WI (US)

(72) Inventors: Michael Lowe, Eau Claire, WI (US); Donald Nelson, Eau Claire, WI (US)

(21) Appl. No.: 13/602,297

(22) Filed: Sep. 3, 2012

Related U.S. Application Data
(60) Provisional application No. 61/530,233, filed on Sep. 1, 2011.

(51) Int. Cl. B01D 50/00; B01D 53/18; B01D 53/02

(52) U.S. Cl. 95/92; 96/142

(57) ABSTRACT

A chamber air scrubber a chamber with an independent air scrubbing system for configured to adsorb plant odors and emissions. The scrubber includes air scrubbers for cleaning the air. The air scrubbers include a carbon portion with active carbon that adsorbs odors and emissions. The carbon portion includes an outer and an inner cylindrical frame that retain active carbon between them. The air scrubbers also include a series of fans that forces air through the carbon portion. The fans allow the air to pass from a lower chamber to an upper chamber. The air enters through an inlet in the lower chamber before passing over a liquid chiller. The air transfers the thermal energy generated by the plants to a vent in the upper chamber. This serves to eliminate odor from the plants.

### CROSS- REFERENCE TO RELATED APPLICATIONS

The present Utility patent application claims priority benefit of the U.S. provisional application for patent Ser. No. 61/530,233 filed on Sep. 1, 2011 and entitled “HYDROPONIC GROWTH CABINET SYSTEM” under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to air scrubbers. More particularly, one or more embodiments of the invention relate to hydroponic chamber air scrubbers.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that hydroponics is a subset of hydroculture and is a method of growing plants using mineral nutrient solutions, in water, without soil. Terrestrial plants may be grown with their roots in the mineral nutrient solution only or in an inert medium, such as perlite, gravel, mineral wool, expanded clay or coconut husk. Another alternative embodiment is growing with soil and containers in place of the hydroponic systems.

Typically, scrubber systems are a diverse group of air pollution control devices that can be used to remove some particulates and/or gases from exhaust streams. The term “scrubber” has referred to pollution control devices that use liquid to wash unwanted pollutants from a gas stream.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary chamber air scrubber, in accordance with an embodiment of the present invention;

FIG. 2 illustrates a sectioned side view of an exemplary chamber air scrubber, in accordance with an embodiment of the present invention;

FIG. 3 illustrates a detailed perspective view of an exemplary upper portion of an exemplary chamber, in accordance with an embodiment of the present invention;

FIG. 4 illustrates a detailed perspective view of an exemplary upper portion of an exemplary chamber, in accordance with an embodiment of the present invention;

FIG. 5 illustrates a detailed perspective view of an exemplary air scrubber, in accordance with an embodiment of the present invention;

FIG. 6 illustrates a sectioned view of an exemplary air scrubber, in accordance with an embodiment of the present invention;

FIG. 7 illustrates a top view of an exemplary air scrubber, in accordance with an embodiment of the present invention;

FIG. 8 illustrates a sectioned side view of an exemplary air scrubber, in accordance with an embodiment of the present invention;

FIGS. 9A and 9B illustrate detailed perspective views of an exemplary carbon portion, where FIG. 9A illustrates an exemplary outer surface and an exemplary inner surface, and FIG. 9B illustrates exemplary foam positioned between an exemplary outer surface and an exemplary inner surface, in accordance with an embodiment of the present invention;

FIG. 10 illustrates a top view of an exemplary carbon portion, in accordance with an embodiment of the present invention;

FIGS. 11A and 11B illustrate detailed perspective views of an exemplary plurality of fans, where FIG. 11A illustrates an exemplary single fan, and FIG. 11B illustrates two fans separated by an exemplary spacer, in accordance with an embodiment of the present invention; and

FIG. 12 illustrates a detailed perspective view of an exemplary air conduit portion, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

There are various types of chamber air scrubbers that may be provided by preferred embodiments of the present invention. In one embodiment of the present invention, the chamber air scrubber may provide a chamber with an independent air scrubbing system configured to adsorb plant odors and emissions. The chamber may include insulation for restricting the dispersal of thermal energy, illumination, and odor.

In one embodiment of the present invention, the chamber may include an upper portion for propagating at least one plant. The upper portion may include at least one air scrubber for cleaning air inside the chamber. Each air scrubber may include a carbon portion configured to adsorb odors and emissions. The carbon portion may include a cylindrical frame outer surface. The outer surface may include a course mesh and a fine mesh that press against each other. An inner surface, also having a cylindrical frame and both types of mesh, may position inside the circumference of the outer surface. Active carbon may fill the space between both surfaces for adsorbing carbon dioxide and other impurities. In some embodiments, the carbon portion may be configured to join securely with the air scrubber. An end cap may provide a terminal surface for a short end of each air scrubber. The end cap may At least one retaining bar may press against the end cap to secure the end cap. At least one rod may pass through the retaining bar, along a longitudinal axis of the at least one air scrubber. At least one fastener may secure each rod against the at least one retaining bar.

In one embodiment of the present invention, the at least one air scrubber may include a plurality of fans. The plurality of fans may orient in a series with a spacer between each fan. Foam may fill the void between each fan and the inner surface to provide a more sealed structure for air to flow through the air scrubber. A fan cord may extend from each fan to provide power from an external power source.

In one embodiment of the present invention, the chamber may include a lower portion for growing the at least one plant. The lower portion may include a liquid reservoir for storing a liquid, and a liquid cooling assembly for cooling the liquid. In some embodiments, the lower chamber may include an air conduit portion for transferring air to the upper chamber and then through the air scrubber. The air conduit portion may include an air inlet portion for receiving air. The air conduit portion may also include a tube or other shape portion for transferring air between chambers while blocking light from going between said chambers. In some embodiments, the lower portion may include at least one substrate surface for containing the at least one plant. An illumination portion may provide illumination to the at least one plant.

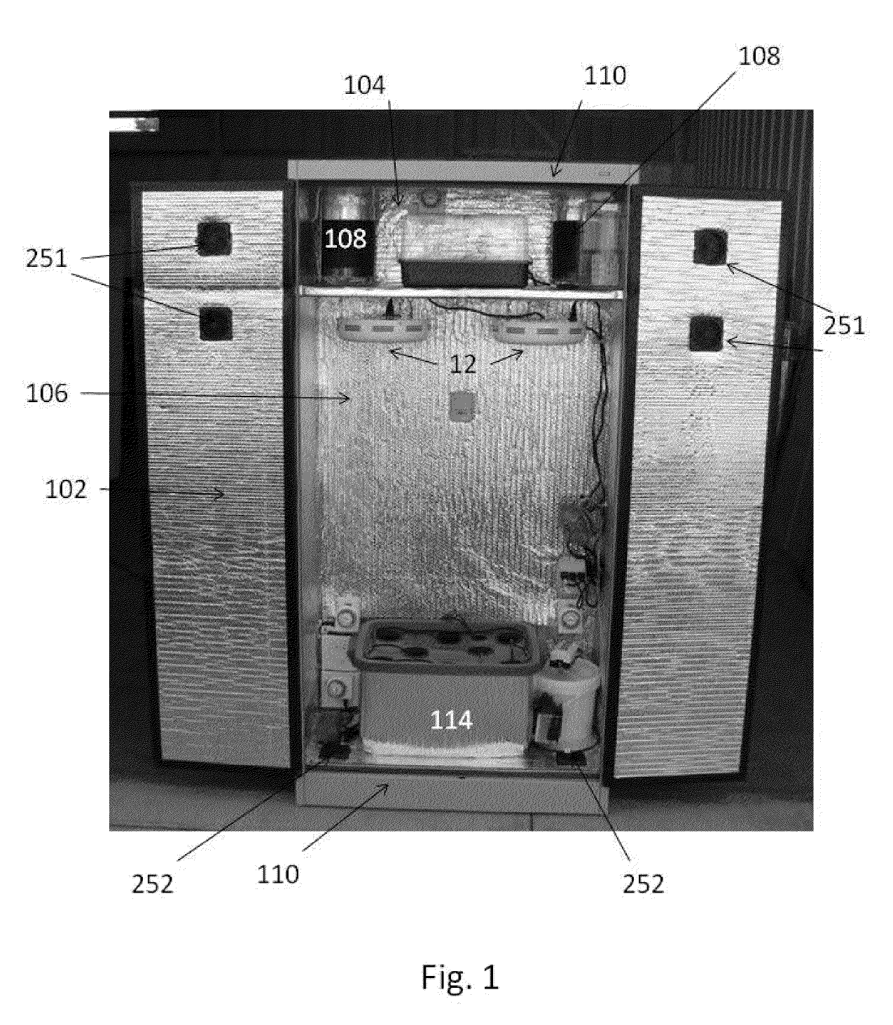

FIG. 1 illustrates a detailed perspective view of an exemplary chamber air scrubber 100, in accordance with an embodiment of the present invention. In the present embodiment, the chamber air scrubber may provide a chamber 102 with an independent air scrubbing system configured to adsorb plant odors and emissions. In one embodiment, the at least one plant may propagate and grow on at least one substrate surface 110, including, without limitation, soil, fertilizer, and water. However, in some embodiments involving hydroponic plants, the substrate surface may include a container of liquid. Suitable materials for fabricating the chamber may include, without limitation, fiberglass, metal, steel, alloy, polyvinyl chloride, plastic, and high density polyurethane. In some embodiments, the chamber may include insulation on the inside surface for restricting the dispersal of thermal energy, illumination, and odor. The insulation may include, without limitation, foam, cellulose, glass wool, rock wool, polystyrene, urethane foam, vermiculite, perlite, wood fiber, plant fiber (cannabis, flax, cotton, cork, etc.), plant straw, animal fiber (sheep's wool), cement, and earth or soil. However, in some embodiments, the insulation may involve a range of designs and techniques to address the requirements hydroponic agriculture, heat transfer, heat conduction, and radiation.

Those skilled in the art, in light of the present teachings, will recognize that the chamber air scrubber may be efficacious in adsorbing plant odors and emissions while growing plants, including, without limitation, increasing air quality, controlling air temperature, replenishing fresh air, removing moisture, removing odor, removing heat, removing emissions, removing dust, removing airborne bacteria and preventing stagnation of air inside the chamber.

In one embodiment of the present invention, the chamber may include an upper portion 104 for propagating at least one plant. Those skilled in the art, in light of the present teachings, will recognize that plant propagation includes creating new plants from a variety of sources, including, without limitation, seeds, cuttings, bulbs, and other plant parts. Plant propagation may be performed separately from plant growth in the chamber. The upper portion may include at least one air scrubber 108 for cleaning and air before exiting the chamber. In some embodiments, each air scrubber may include a carbon portion configured to adsorb plant odors and emissions. However, in other embodiments, additional impurities may be removed from the air.

In one embodiment, the carbon portion may include a cylindrical frame outer surface. However, in other embodiments, the frame may include various shapes and sizes, including, without limitation, a rectangle, a square, a sphere, and a triangle. The size of the chamber may also dictate the size of the carbon portion. The outer surface may include a course mesh and a fine mesh that press against each other. The synergy created between the two differently sized meshes may enhance the air purification process. In some embodiments, a filter may position between the meshes. However, in other embodiments, the meshes may serve as the filter. An inner surface, also having a cylindrical frame and both types of mesh, may position inside the circumference of the outer surface. Active carbon may fill the space between both surfaces for adsorbing plant odors and emissions.

In some embodiments, the carbon portion may be configured to join securely with the air scrubber. An end cap may provide a terminal surface for a short end of each air scrubber. At least one retaining bar may press against the end cap to secure the end cap. In some embodiments, at least one rod may pass through the retaining bar, along a longitudinal axis of the at least one air scrubber. At least one fastener may secure each rod against the at least one retaining bar. The fastener may include, without limitation, a nut, a wing nut, a screw, a nail, a magnet, and an adhesive.

In one embodiment of the present invention, the at least one air scrubber may include a plurality of fans. The plurality of fans may orient in a series with a spacer between each fan. Those skilled in the art, in light of the present teachings, will recognize that multiple lower cubic feet per minute fans being used in series may accomplish the same work as single, louder high cubic feet per minute fan. Foam may fill the void between each fan and the inner surface to provide a more sealed structure for air to flow through the air scrubber. The foam may also serve to mount and seal the plurality of fans within the carbon portion. However, in other embodiments, other insulation may be utilized to secure the plurality of fans, including, without limitation polystyrene, urethane foam, and vermiculite. A fan cord may extend from each fan to provide power from an external power source. In one alternative embodiment, the chamber air scrubber may include an independent power source, including a battery and a solar panel.

In one embodiment of the present invention, the chamber may include a lower portion 106 for growing the at least one plant. Those skilled in the art will recognize that the fundamental elements for growing plants hydroponic plants may include, without limitation, a liquid, illumination, and oxygen. The lower portion may include a liquid reservoir 114 for storing a liquid, and a liquid cooling assembly for cooling the liquid. The liquid may include, without limitation, water and liquid fertilizer. In some embodiments, the liquid cooling assembly may join with the liquid reservoir.

In one embodiment of the present invention, the lower chamber may include an air conduit portion for transferring air to the upper chamber and the air scrubber. The air conduit portion may include an air inlet portion for receiving air. Those skilled in the art, in light of the present teachings will recognize that growing plants may produce odors and emissions. The chamber air scrubber may require dispersing odors and emissions from the plants through a vent, and receiving fresh air from the air inlets. The lower chamber main air conduit portion may also include a tube or other shaped portion for carrying air into the lower chamber In this manner, air may pass over the liquid cooling assembly in the lower portion to disperse heat, thermal energy and used air from the chamber. In some embodiments, the lower portion may include at least one substrate surface for containing the at least one plant. The substrate may include, without limitation, soil, fertilizer, and water. However, in some embodiments that grow plants hydroponically, the substrate may include solely water. Those skilled in the art, in light of the present teachings will recognize that photosynthesis is a natural cycle that must occur to grow plants. Photosynthesis may include the plants converting solar energy, or illumination into energy for growth. Therefore, the lower chamber may include an illumination portion 112 may provide illumination to the at least one plant.

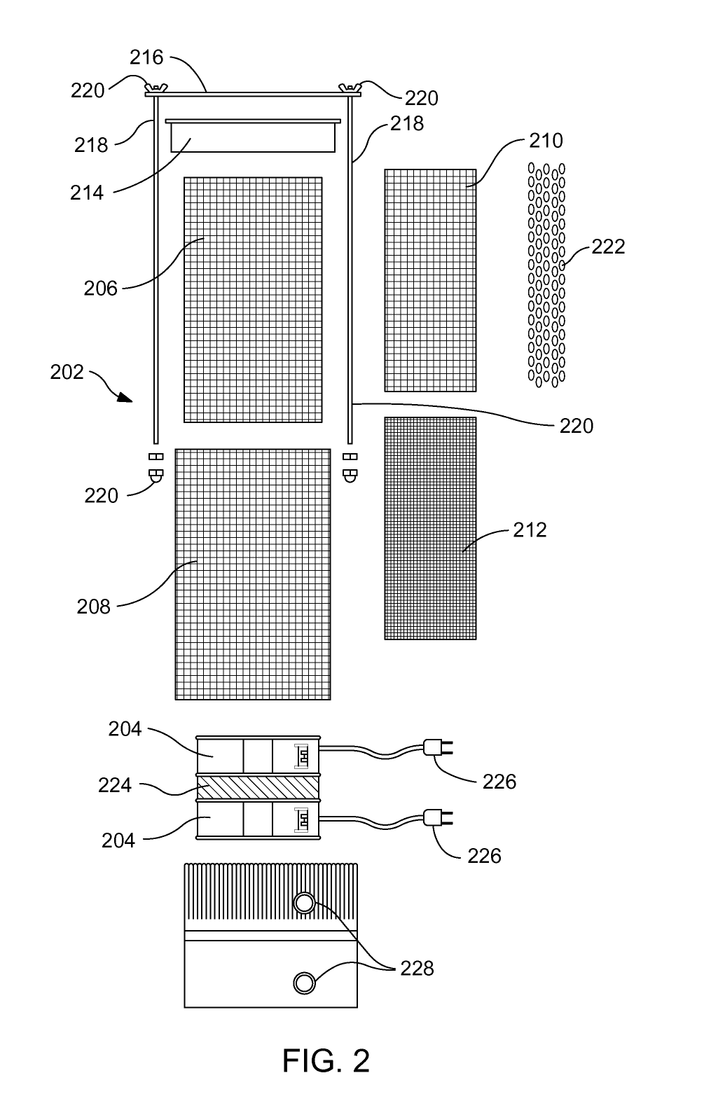

FIG. 2 illustrates a sectioned side view of an exemplary chamber air scrubber, in accordance with an embodiment of the present invention. In the present embodiment, each air scrubber may include a carbon portion 202 designed to adsorb odors and emissions. However, in other embodiments, additional impurities may be removed from the air.

In one embodiment, the carbon portion may include a cylindrical frame outer surface 206. However, in other embodiments, even if not optimal for at least some applications, the frame may include various shapes and sizes, including, without limitation, a rectangle, a square, a sphere, and a triangle. The size of the chamber may also dictate the size of the carbon portion. The outer surface may include a course mesh 210 and a fine mesh 212 that press against each other. The synergy created between the two differently sized meshes may enhance the air purification process. In some embodiments, a filter may position between the meshes. However, in other embodiments, the meshes may serve as the filter. An inner surface 208, also having a cylindrical frame and both types of mesh, may position inside the circumference of the outer surface. Active carbon 222 may fill the space between both surfaces for adsorbing impurities.

In some embodiments, the carbon portion may be configured to join securely with the air scrubber. An end cap 214 may provide a terminal surface for a short end of each air scrubber. At least one retaining bar 216 may press against the end cap to secure the end cap. In some embodiments, at least one rod 218 may pass through the retaining bar, along a longitudinal axis of the at least one air scrubber. At least one fastener 220 may secure each rod against the at least one retaining bar. The fastener may include, without limitation, a nut, a wing nut, a screw, a nail, a magnet, and an adhesive.

In one embodiment of the present invention, the at least one air scrubber may include a plurality of fans 204. In many practical applications, the low cfm's for the fans may not improve efficiency, instead they may make the system operate more quietly. For example, without limitation, multiple lower cfm fans in series might do roughly the same work as one higher cfm, yet at significantly lower fan noise level when pulling air through the carbon filter. The plurality of fans may orient in a series with a spacer 224 between each fan. Those skilled in the art, in light of the present teachings, will recognize that multiple lower cubic feet per minute fans being used in series may accomplish the same work as single, louder high cubic feet per minute fan. Foam may fill the void between each fan and the inner surface to provide a more sealed structure for air to flow through the air scrubber. The foam may also serve to mount and seal the plurality of fans within the carbon portion. However, in other embodiments, other insulation may be utilized to secure the plurality of fans, including, without limitation polystyrene, urethane foam, and vermiculite. A fan cord 226 may extend from each fan to provide power from an external power source. In one alternative embodiment, the chamber air scrubber may include an independent power source, including a battery and a solar panel.

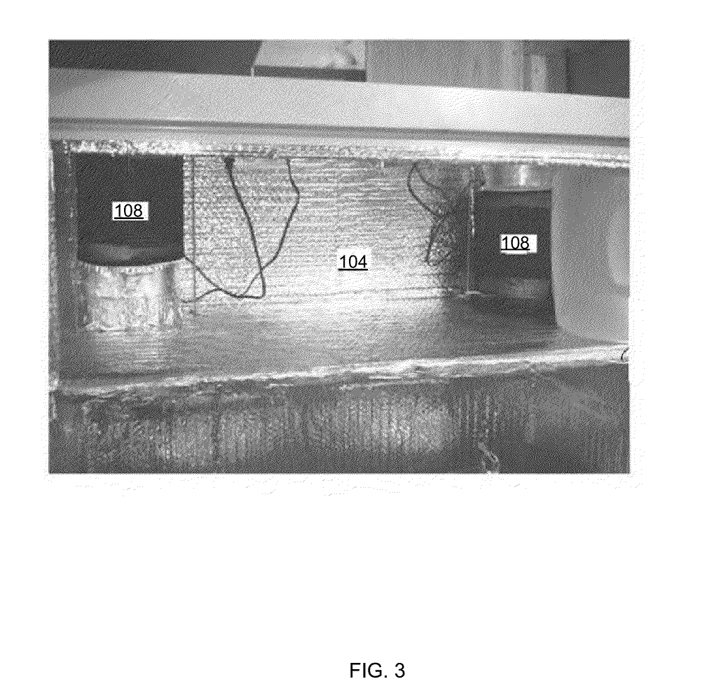

FIG. 3 illustrates a detailed perspective view of an exemplary upper portion of an exemplary chamber, in accordance with an embodiment of the present invention. In the present embodiment, the upper portion may provide an area in the chamber for propagating the plants. The plants may transfer to the lower portion after propagation.

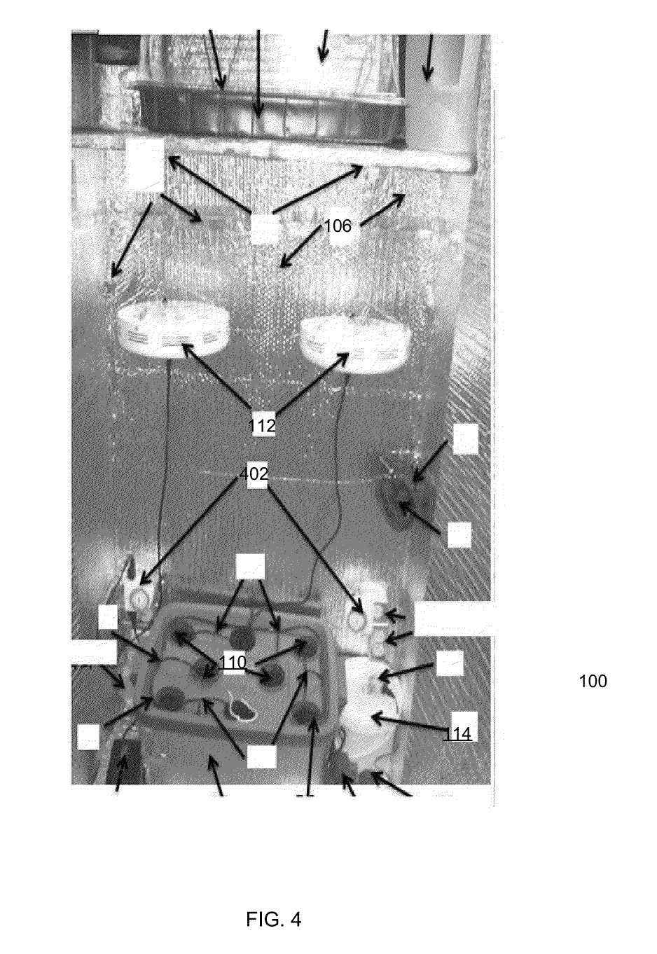

FIG. 4 illustrates a detailed perspective view of an exemplary upper portion of an exemplary chamber, in accordance with an embodiment of the present invention. In the present embodiment, the lower portion may include a liquid reservoir for storing a liquid, and a liquid cooling assembly 402 for cooling the liquid. The liquid may include, without limitation, water and liquid fertilizer. In some embodiments, the liquid cooling assembly may join with the liquid reservoir.

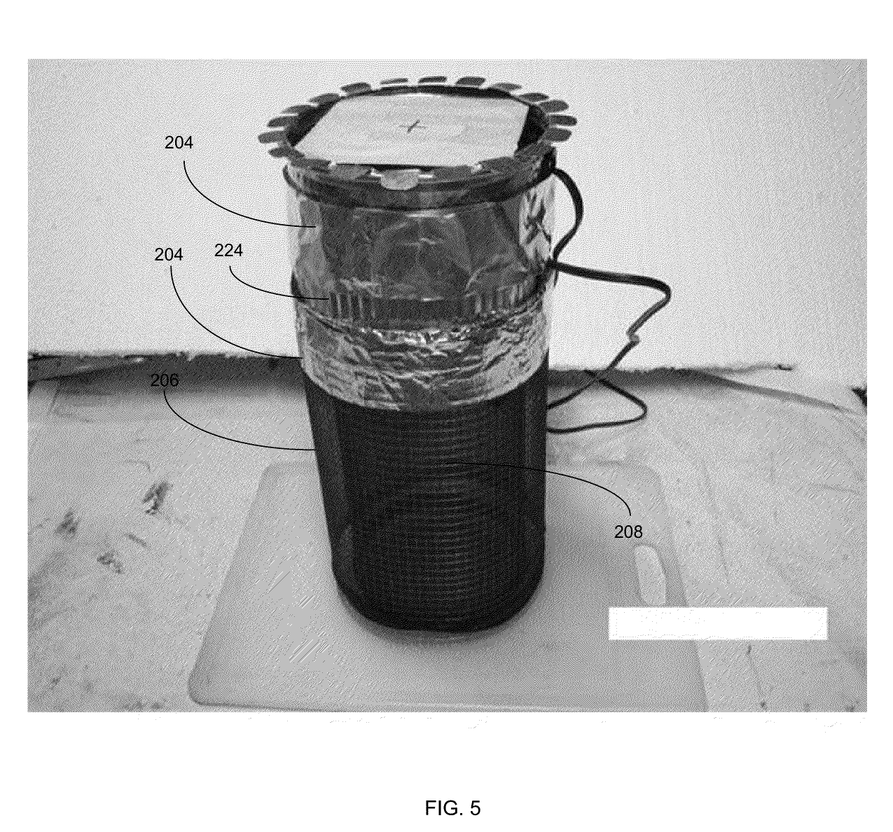

FIG. 5 illustrates a detailed perspective view of an exemplary air scrubber, in accordance with an embodiment of the present invention. In the present embodiment, the chamber air scrubber may provide a chamber with an independent air scrubbing system configured to adsorb plant odors and emissions. The chamber may include insulation for restricting the dispersal of thermal energy, illumination, and odor. In this manner, odor may be restricted from emanating from the chamber.

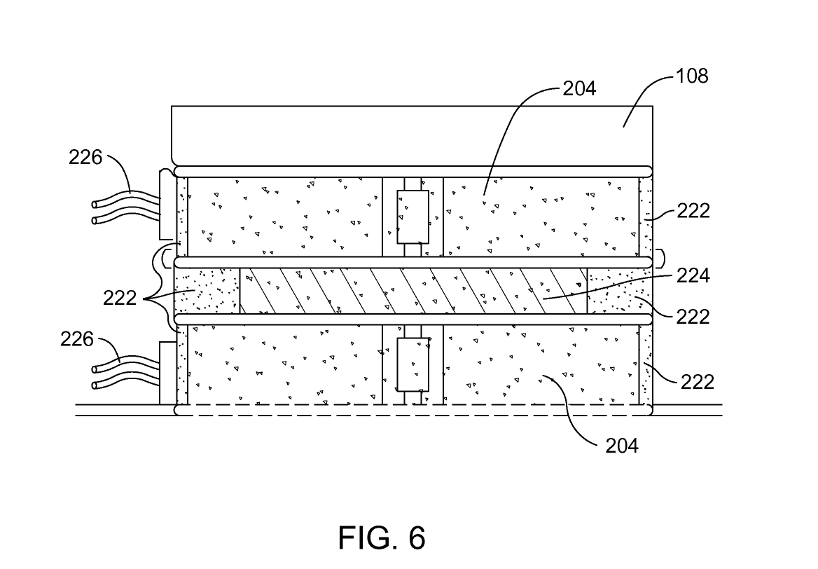

FIG. 6 illustrates a sectioned view of an exemplary air scrubber, in accordance with an embodiment of the present invention. In the present embodiment, the at least one air scrubber may include a plurality of fans. The plurality of fans may orient in a series with a spacer between each fan. The at least one air scrubber may further include a carbon portion for adsorbing carbon dioxide. The plurality of fans and the carbon portion create a synergy that forms a novel air scrubbing assembly inside the chamber.

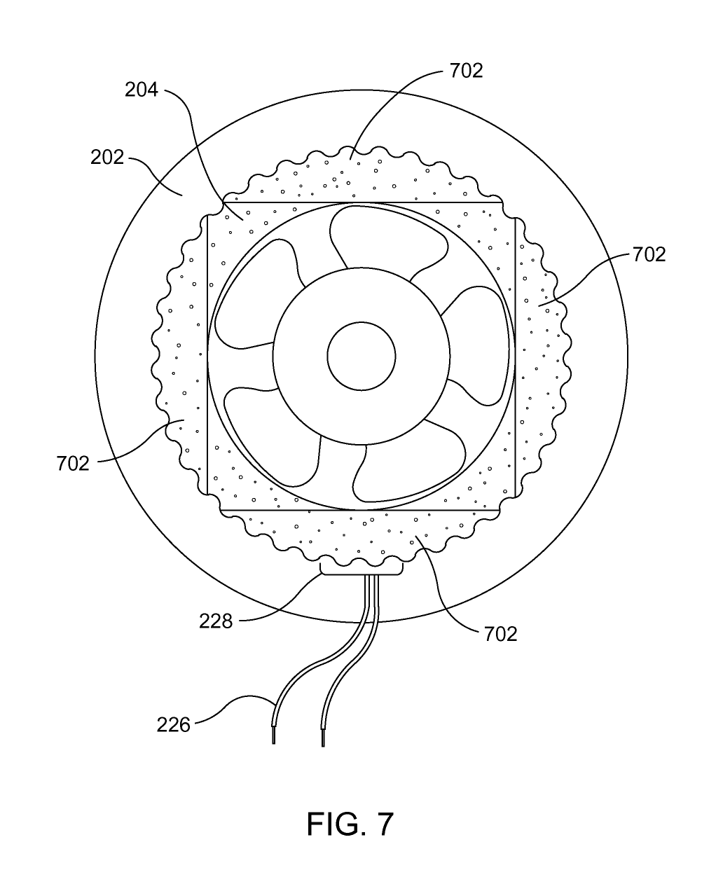

FIG. 7 illustrates a top view of an exemplary air scrubber, in accordance with an embodiment of the present invention. In the present embodiment, foam 702 may fill the void between each fan and the inner surface to provide a more sealed structure for air to flow through the air scrubber. The foam may also serve to mount and seal the plurality of fans within the carbon portion. However, in other embodiments, other insulation may be utilized to secure the plurality of fans, including, without limitation polystyrene, urethane foam, and vermiculite.

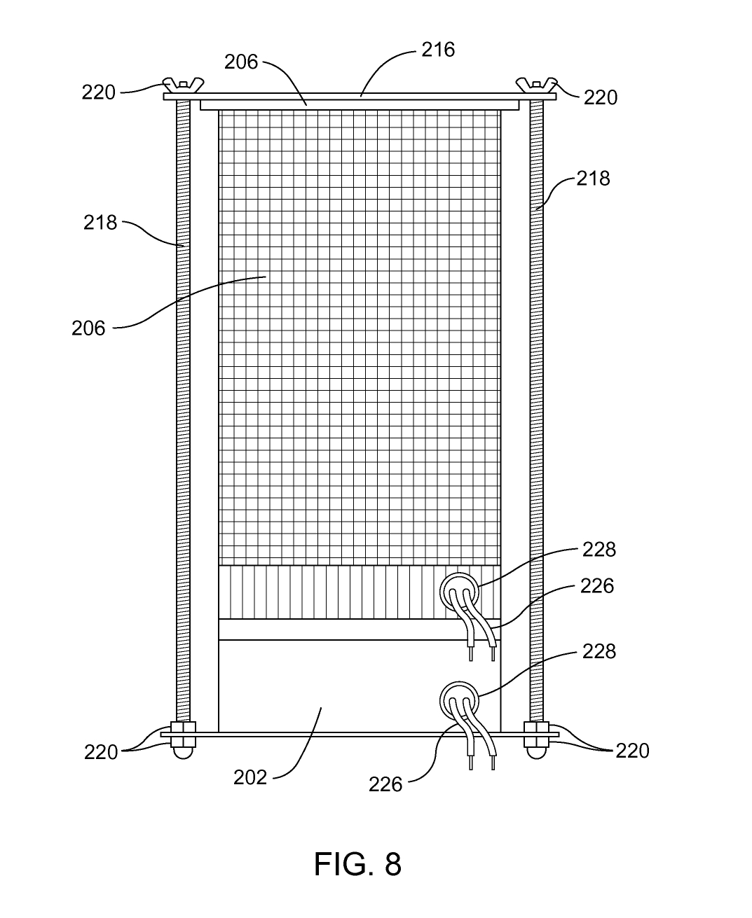

FIG. 8 illustrates a sectioned side view of an exemplary air scrubber, in accordance with an embodiment of the present invention. In the present embodiment, the components of the at least one air scrubber may be easily obtained and assembled.

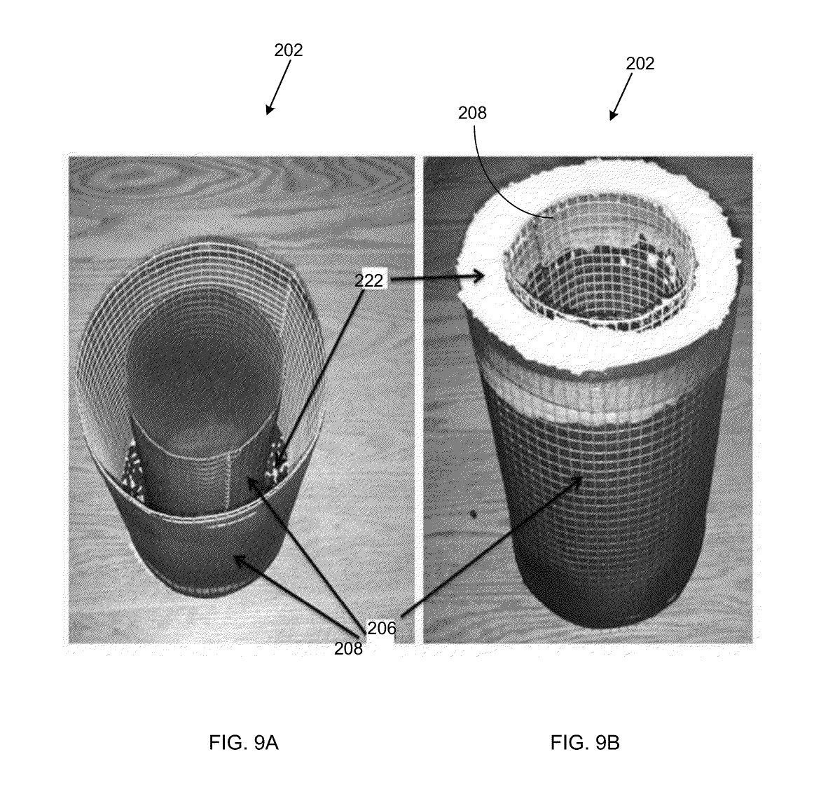

FIGS. 9A and 9B illustrate detailed perspective views of an exemplary carbon portion, where FIG. 9A illustrates an exemplary outer surface and an exemplary inner surface, and FIG. 9B illustrates exemplary foam positioned between an exemplary outer surface and an exemplary inner surface, in accordance with an embodiment of the present invention. In the present embodiment, active carbon is configured to adsorb plant odors and emissions. Those skilled in the art, in light of the present teachings will recognize that active carbon is a form of carbon processed to be riddled with small, low-volume pores that increase the surface area available for adsorption of particles coming through the chamber.

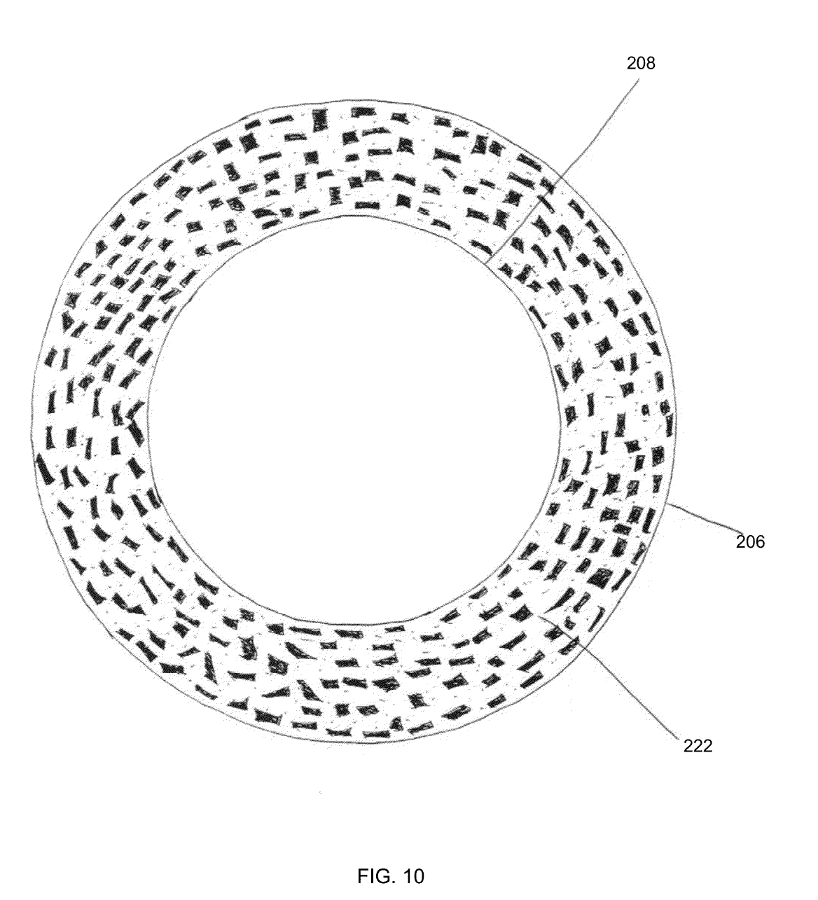

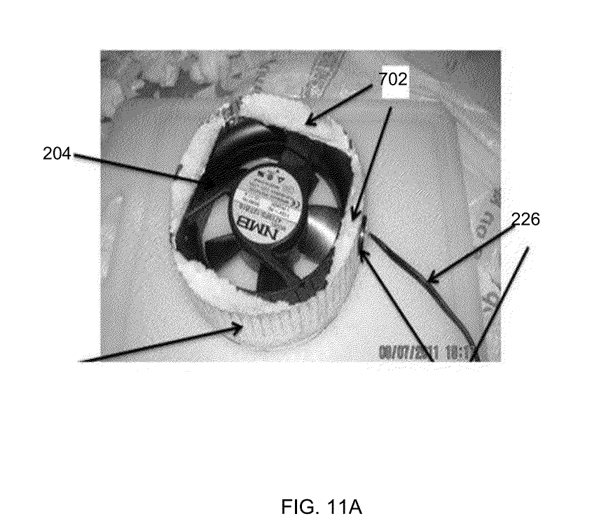

FIG. 10 illustrates a top view of an exemplary carbon portion, in accordance with an embodiment of the present invention. In the present embodiment, the active carbon may position between the outer surface and the inner surface. However, in other embodiments, the active carbon may position inside porous packets.

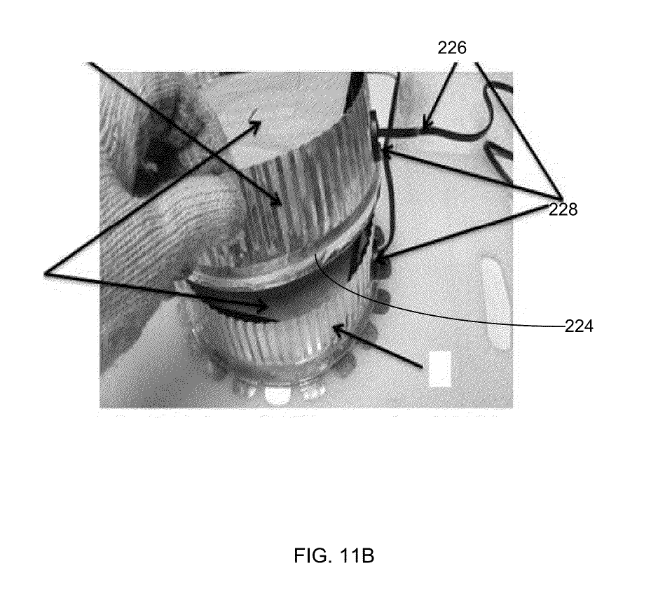

FIGS. 11A and 11B illustrate detailed perspective views of an exemplary plurality of fans, where FIG. 11A illustrates an exemplary single fan, and FIG. 11B illustrates two fans separated by an exemplary spacer, in accordance with an embodiment of the present invention. In the present embodiment, the present invention may utilize a plurality of fans oriented in a series to force air through the chamber. In at least some practical applications, two to three fans in a series may be optimal.

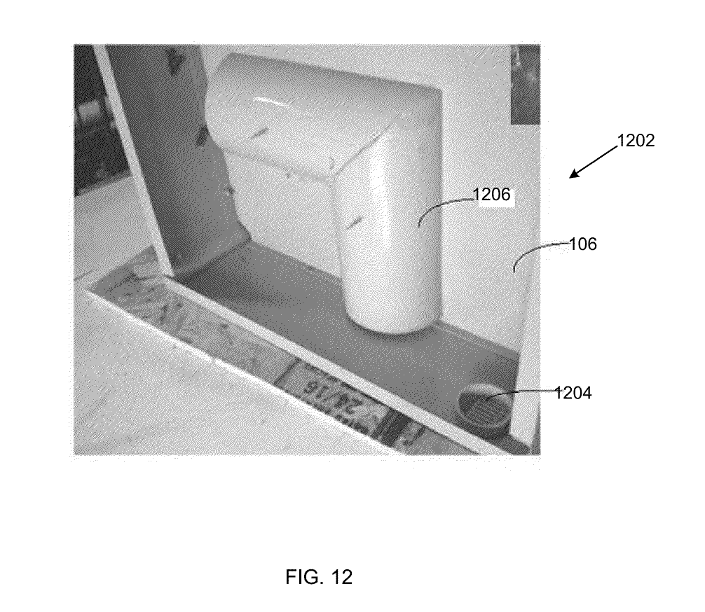

FIG. 12 illustrates a detailed perspective view of an exemplary air conduit portion 1202, in accordance with an embodiment of the present invention. In the present embodiment, the lower chamber may include an air conduit portion for transferring air to the air scrubber. The air conduit portion may include an air inlet portion 1204 for receiving air. Those skilled in the art, in light of the present teachings will recognize that growing plants produce odors and emissions. The chamber air scrubber may require dispersing odors and emissions from the plants through a vent, and receiving fresh air from the lower chamber air inlet. The air conduit portion may also include a tube, or other suitable shape, portion 1206 for carrying air from the lower chamber to the upper chamber through the vent system (251), then passes through the air scrubber system and is then vented out the cabinet through the back, top or side depending on application. In this manner, air may pass over the liquid cooling assembly in the lower chamber to disperse heat, and contaminated air—from the chamber. It should be noted that portion 1206 may be a simple piece of bent metal, which, in many practical applications, is at least useful for blocking the light inside the grow chamber, by way of example, by providing an angle which is capable for blocking light passage. All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing an air scrubber system that utilizes a series of fans working in synergy with active carbon to remove odor and emissions from a plant growing chamber according to the present invention will be apparent to those skilled in the art. Various aspects of the invention have been described above by way of illustration, and the specific embodiments disclosed are not intended to limit the invention to the particular forms disclosed. The particular implementation of the air scrubber system that utilizes a series of fans working in synergy with active carbon to minimize odor and emissions from a hydroponic chamber may vary depending upon the particular context or application. By way of example, and not limitation, the air scrubber system that utilizes a series of fans working in synergy with active carbon to minimize odor and emissions from a hydroponic chamber described in the foregoing were principally directed to air scrubber system that utilizes a series of fans working in synergy with active carbon to minimize odor and emissions from a hydroponic chamber implementations; however, similar techniques may instead be applied to filtering air in a hospital, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A chamber air scrubber comprising:
a chamber, said chamber being configured to help enhance air quality, said chamber comprising an upper portion, said upper portion comprising at least one air scrubber, said at least one air scrubber comprising a carbon portion, said carbon portion being configured to adsorb odors and emissions from air, said carbon portion comprising an outer surface, said carbon portion further comprising an inner surface, said inner surface being disposed to enclose a plurality of fans, said plurality of fans being operable to force air through said carbon portion, said plurality of fans being disposed to position in a series along a longitudinal axis of said carbon portion, said chamber further comprising a lower portion, said lower portion comprising an air conduit portion, said air conduit portion being configured to transfer air through said at least one air scrubber, said lower portion further comprising a liquid reservoir, said liquid reservoir comprising a liquid cooling assembly.

2. The chamber air scrubber of claim 1, in which said chamber comprises a hydroponic plant chamber.

3. The chamber air scrubber of claim 2, in which said chamber comprises insulation, said insulation being configured to restrict the dispersal of odor and illumination from said chamber.

4. The chamber air scrubber of claim 3, in which said upper portion is configured to propagate said at least one plant.

5. The chamber air scrubber of claim 4, in which said plurality of fans comprise two fans aligned in series.

6. The chamber air scrubber of claim 5, wherein said plurality of fans comprise at least one spacer, said at least one spacer being configured to separate said plurality of fans.

7. The chamber air scrubber of claim 6, in which said plurality of fans comprise a high cubic feet per minute flow rate for air while being quiet.

8. The chamber air scrubber of claim 7, wherein said plurality of fans are operable to force air in two directions.

9. The chamber air scrubber of claim 8, in which said plurality of fans comprise a fan cord, said fan cord being operable to provide power from an external power source, said fan cord being disposed to extend from each fan to an exterior area of said at least one air scrubber through an insert.

10. The chamber air scrubber of claim 9, wherein foam positions between said plurality of fans and said carbon portion.

11. The chamber air scrubber of claim 10, in which said inner surface comprises a cylindrical frame, said cylindrical frame comprising a coarse mesh, said cylindrical frame further comprising a fine mesh.

12. The chamber air scrubber of claim 11, in which said outer surface comprises a cylindrical frame, said cylindrical frame comprising a coarse mesh, said cylindrical frame further comprising a fine mesh.

13. The chamber air scrubber of claim 12, in which said carbon portion comprises an end cap, said end cap being configured to provide a terminal surface for said carbon portion, said carbon portion further comprising at least one retaining bar, said retaining bar being configured to secure said end cap, said carbon portion further comprising at least one rod, said at least one rod being configured to pass through said at least one retaining bar, said carbon portion further comprising at least one fastener, said fastener being configured to secure said at least one retaining bar to said at least one rod.

14. The chamber air scrubber of claim 13, which said carbon portion comprises active carbon, said active carbon being disposed to position between said outer surface and said inner surface.

15. The chamber air scrubber of claim 14, wherein said lower portion is configured to grow said at least one plant, said lower portion comprising at least one substrate surface, said at least one substrate surface being configured to contain said at least one plant.

16. The chamber air scrubber of claim 15, in which said lower portion comprises an illumination portion, said illumination portion being configured to provide illumination to said at least one plant.

17. The chamber air scrubber of claim 16, in which said lower portion comprises a liquid reservoir, said liquid reservoir being configured to store a liquid, said lower portion further comprising a liquid cooling assembly, said liquid cooling assembly being configured to cool said liquid.

18. The chamber air scrubber of claim 17, in which said air conduit portion comprises an air inlet portion, said air conduit portion further comprising a tube portion, said tube portion being configured to carry air through said lower chamber while completely blocking light from escaping, said tube portion further being configured to carry air past said liquid cooling assembly, said air conduit portion further comprises a vent, said vent being configured to disperse air to said upper portion.

19. A method of scrubbing air comprising:
means for positioning at least one plant inside a chamber;
means for passing air from said lower portion to said upper portion;
means for passing air over a liquid cooling assembly;
means for passing air through at least one air scrubber;
means for adsorbing odors and emissions from said air;
means for forcing air via a plurality of fans;
means for providing illumination for said at least one plant; and
means for growing said at least one plant.

20. A chamber air scrubber consisting of:
a chamber, said chamber being configured to adsorb odors and emissions, said chamber comprising a hydroponic plant chamber, said chamber comprising an upper portion, said upper portion being configured to propagate at least one plant, said upper portion comprising at least one air scrubber, said at least one air scrubber comprising a carbon portion, said carbon portion being configured to adsorb odors and emissions from air, said carbon portion comprises an end cap, said end cap being configured to provide a terminal surface for said carbon portion, said carbon portion further comprising at least one retaining bar, said retaining bar being configured to secure said end cap, said carbon portion further comprising at least one rod, said at least one rod being configured to pass through said at least one retaining bar, said carbon portion further comprising at least one fastener, said fastener being configured to secure said at least one retaining bar to said at least one rod, said carbon portion further comprising an outer surface, said outer surface comprising a cylindrical frame, said cylindrical frame comprising a coarse mesh, said cylindrical frame further comprising a fine mesh, said carbon portion further comprising an inner surface, said inner surface comprising a cylindrical frame, said cylindrical frame comprising a coarse mesh, said cylindrical frame further comprising a fine mesh, said inner surface being disposed to enclose a plurality of fans, said plurality of fans being operable to force air through said carbon portion, said plurality of fans being disposed to position in a series along a longitudinal axis of said carbon portion, said chamber further comprising a lower portion, said lower portion comprising a liquid reservoir, said liquid reservoir comprising a liquid cooling assembly, said lower portion further comprising an air conduit portion, said air conduit portion being configured to transfer air through lower chamber to at least one air scrubber, said air conduit comprising a conduit portion, said tube portion being configured to carry air to lower chamber, said conduit portion further being configured to carry air through said liquid cooling assembly, said conduit portion further being configured to carry air to said upper portion.
